(19) United States
(12) Patent Application Publication
(10) Pub. No.: US 2002/0059618 A1
(43) Pub. Date: May 16, 2002

(54) Video on demand

(76) Inventor: Johan I.J. Venter, Pretoria (ZA)

Correspondence Address: BAKER & BOTTS, 30 ROCKEFELLER PLAZA, NEW YORK, NY, 10112

(21) Appl. No.: 09/867,870

(22) Filed: May 30, 2001

(30) Foreign Application Priority Data
May 30, 2000 (ZA) 2000/02688

(51) Int. Cl. H04N 7/173

(52) U.S. Cl. 725/87

(57) ABSTRACT

A system for providing a video-on-demand service comprises a repository of video programs, an administration facility associated with the repository of video programs, one or more television broadcast receivers remote from the repository, a satellite communication channel capable of carrying a television broadcast signal between the repository and the television broadcast receivers, and a television broadcast transmitter capable of broadcasting any selected one of the video programs in the repository along the satellite communication channel to the television broadcast receivers.

The administration facility has a register of authorized users of the repository, and each television broadcast receiver has an associated storage means in the form of a hard disk drive. The broadcast selected video program is stored, at least partially, upon reception thereof, in the associated storage means of the television broadcast receivers. An activation facility responsive to a request by a registered user enables the stored selected video program for viewing on the television broadcast receiver.

A billing facility bills the authorized user as a function of a number of stored video programs viewed by that user.

### FIELD OF THE INVENTION

This invention relates to a system for providing a video-on-demand (“VOD”) service and, more particularly, to a VOD service in which a video programme, which is to be viewed, is disseminated by means of a satellite broadcast. The invention extends to a method for providing a true VOD service.

### BACKGROUND TO THE INVENTION

VOD via satellite requires a user to request a specific video programme from a menu displayed on a television monitor, After the user has made a selection, a request is sent via a return link to a repository of multiple video programmes, and the specific requested video programme is then transmitted (“downloaded”) via a satellite broadcast link to a set-top box in the user's home. The downloaded video programme is stored on a storage disk in the set top box and has a finite residence time. During this residence time, the user may view the video programme at leisure; whereafter the video programme will be deleted from the storage disk. The user is billed for each video programme that is downloaded from the repository.

In order to provide an adequate response to the user, it is desirable that the entire video programme should be transmitted from the repository to the set-top box within an a short time, typically a few minutes, after the request, in order to minimise the elapsed time between the request and availability of the video programme for viewing the by the user.

In order to achieve this result video streaming may be utilised. Video streaming is a method of delivering video, audio, or other multimedia content to a computer workstation via the Internet in which a recipient is provided with instant access to the programme content Streaming video begins to play shortly after the user requests the programme, thus providing an immediate experience, generally at the cost of a decrease in quality relative to a video programme that begins to play only after completion of a download. Streaming Internet video represents a first mass-market implementation of video on demand. An Internet website having well designed video elements can provide a viewer with an experience that broadcast television cannot match.

Video streaming is normally implemented by means of a Internet Protocol (IP) multi-casting which is a technology enabling multiple computer workstations to simultaneously access a single stream of data.

Video file formats such as Quicktime, AVI or MPEG require that such a video programmes be downloaded in their entirety before being displayed. This usually takes some time. Encoders are known which convert files from these standard video file formats into video streaming formats using different proprietary compression algorithms.

VOD via satellite has been technologically impossible end economically infeasible till now due to bandwidth limitations. Video transmission via satellite, although much faster than by means of land line or mobile telephony, is still not fast enough to make true VOD feasible, and is also bandwidth-intensive. Video transmission by means of optical fibre cable is in use where such cable networks already exist, although such networks are prohibitively expensive to install from scratch.

Satellite bandwidth is usually leased from satellite operators in blocks, each corresponding to the bandwidth capacity of a single transponder although, more recently, it has become possible to lease satellite bandwidth in 2 MHz blocks. Satellite transponders can vary in bandwidth capacity from 24 MHz to 72 MHz, but typically have a bandwidth of 36 MHz. A satellite generally has between 8 and 18 transponders, but typically 12.

A 36 MHz satellite transponder can support a data rate of approximately 45 megabits per second. After providing for error correction, conditional access coding, signalling, monitoring and control, and the like, the maximum information data rate that can be carried by such a transponder is approximately 39 megabits per second.

Most satellite communication systems are narrow band systems, in that the maximum channel bandwidth is limited to the bandwidth of a single transponder. There are two ways of implementing true VOD that determine the way a satellite's transponders are utilised. A first way is to utilise the available bandwidth to transmit a multiplicity of simultaneous video streams to different users, while the other is to utilise the entire bandwidth to transmit a single video stream to a single user as quickly as possible. In order to assess these alternatives, consider an example of a 90-minute video programme broadcast at videocassette recorder (“VHS”) -quality. In order to achieve VHS-quality, a bit rate of 1, 2 megabits per second is sufficient. Thus the video programme requires transmission of 6, 48 Gigabits of information.

According to the first approach, multiple uses each receive a real time video stream at a bit rate of 1, 2 megabits per second. Each of the streams can be encoded and compressed according to an MPEG-2 compression scheme. With a transponder bandwidth of 39 megabits per second 32, simultaneous video streams can be broadcast on one transponder. Each stream can be buffered and stored on a users set-top box and can be used to provide VCR-like functionality.

This enables 32 video programmes to be transmitted per transponder every 90 minutes, which is equivalent to 21 video programmes per hour. Each user requires equipment with a bandwidth of 1, 2 megabits per second. This arrangement allows programme to start within a few seconds of a request for the video programme by a user.

According to the second approach, the video programme of 6, 48 Gigabits can be transferred to a user in just under three minutes, (166 seconds) by using the entire transponder bandwidth of 39 megabits per second. This approach also enables 21 video programmes to be transmitted per hour. The user, however, requires equipment with a bandwidth of 39 megabits per second.

A comparison of these two approaches indicates that the first approach relaxes the maximum data handling capacity required for the user equipment, which has advantageous cost implications. In addition, the time before commencing playing of the video programme is minimised. Since the total bandwidth used is identical in the two approaches, both can carry the same number of video streams per hour. In this example, it is clear that, by using the entire bandwidth of a satellite having 12 transponders, only 384 video-on-demand subscribers can be satisfied at any given point in time. Such an arrangement would require the provision of a dedicated satellite and is clearly unnecessarily expensive.

### OBJECT OF THE INVENTION

It is an object of this invention to provide a system for providing a video-on-demand service and a method for providing a video-on-demand service that will, at least partially, alleviate the above-mentioned difficulties and disadvantages.

### SUMMARY OF THE INVENTION

In accordance with this invention there is provided a system for providing a video-on-demand service, comprising;

a repository of video programmes

an administration facility associated with the repository of video programmes, the administration facility having a register of authorised users of the repository;

at least one television broadcast receiver remote from the repository, the at least one television broadcast receiver having an associated storage means;

a satellite communication channel between the repository and the at least one television broadcast receiver, the satellite communication channel being capable of carrying a television broadcast signal;

transmitter means capable of broadcasting any selected one of the video programmes in the repository along the satellite communication channel, the broadcast selected one of the video programmes being stored, at least partially, upon reception thereof, in the associated storage means; and an activation facility responsive to a request by a registered user to enable the stored selected one of the video programmes for viewing on the television broadcast receiver.

Further features of the invention provide for the system to include a billing facility operable to bill the registered user of the system as a function of a number of stored video programmes viewed by the registered user, for the activation facility to be a return communication channel operable by the registered user to access the administration facility, and for the return communication channel to be a terrestrial or a satellite telecommunication circuit, and for the telecommunication circuit to be a leased or a dial-up telecommunication circuit.

Still further features of the invention provide for a plurality of selected video programmes in the repository to be broadcast along the satellite communication channel and stored in the storage means associated with the at least one television broadcast receiver, and for the activation facility to be operable by the registered user to enable any one of the plurality of selected stored video programmes for viewing on the television broadcast receiver,

Yet further features of the invention provide for the plurality of video programmes transmitted from the repository and stored in the storage means to be selected at the discretion of the registered user, alternatively for the plurality of video programmes to be selected according to box office ratings, further alternatively for the plurality of video programmes to be selected to as a function of a historical viewing pattern of the registered user, and for the historical viewing pattern of the registered user to be determined as a function of an evaluation of any video programme after viewing thereof by the registered user.

There is further provided for the plurality of video programmes transmitted from the repository and stored in the storage means to have a finite residence time in the storage means, for a stored video programme to be erased from the storage means after effluxion of the finite residence time, alternatively for the plurality of video programmes to be stored in the storage means until viewed by the registered user, and for the administration facility to prompt the registered user to select a replacement video programme for transmission and storage after erasure of any video programme from the storage means.

The invention extends to a method for providing a video-on-demand service, comprising the steps of:

providing a repository of video programmes;

providing an administration facility associated with the repository of video programmes, the administration facility having a register of authorised users of the repository;

providing at least one television broadcast receiver remote from the repository, the at least one television broadcast receiver having an associated storage means;

broadcasting any selected one of the video programmes in the repository along a satellite communication channel to the at least one television broadcast receiver; storing, at least partially, the broadcast selected one of the video programmes, upon reception thereof, in the associated storage means; and enabling the stored selected one of the video programmes for viewing on the television broadcast receiver in response to a request by a registered user.

There is further provided for billing the registered user as a function of a number of stored video programmes viewed by the registered user, and for enabling the stored selected one of the video programs for viewing by submitting a request to the administration facility, and for submitting the request to the administration facility along a dial up telecommunication circuit.

There is still further provided for broadcasting a plurality of selected video programmes in the repository along the satellite communication channel and storing the plurality of selected video programmes in the storage means associated with the at least one television broadcast receiver, and for enabling any one of the stored selected video programmes for viewing on the television broadcast receiver in response to a request by the registered user.

There is yet further provided for selecting the plurality of video programmes transmitted from the repository and stored in the storage means at the discretion of the registered user, alternatively for selecting the plurality of video programmes according to box office ratings, further alternatively for selecting the plurality of video programmes as a function of historical viewing pattern of the registered user, and for determining the historical viewing pattern of the registered user as a function of an evaluation of any video programme after viewing thereof by the registered user.

There is also provided for the plurality of video programmes transmitted from the repository and stored in the storage means to have a finite residence time in the storage means, for erasing a stored video programme from the storage means after effluxion of the finite residence time, alternatively for storing the plurality of video programmes in the storage means until viewed by the registered user, and for prompting the registered user to select a replacement video programme for transmission and storage after erasure of any video programme from the storage means.

### BRIEF DESCRIPTION OF THE DRAWINGS

A preferred embodiment of the invention is described below, by way of example only, and with reference to the accompanying drawings in which:

FIG. 1. is a schematic representation of a system for providing video on demand in accordance with the invention.

### DETAILED DESCRIPTION OF THE INVENTION

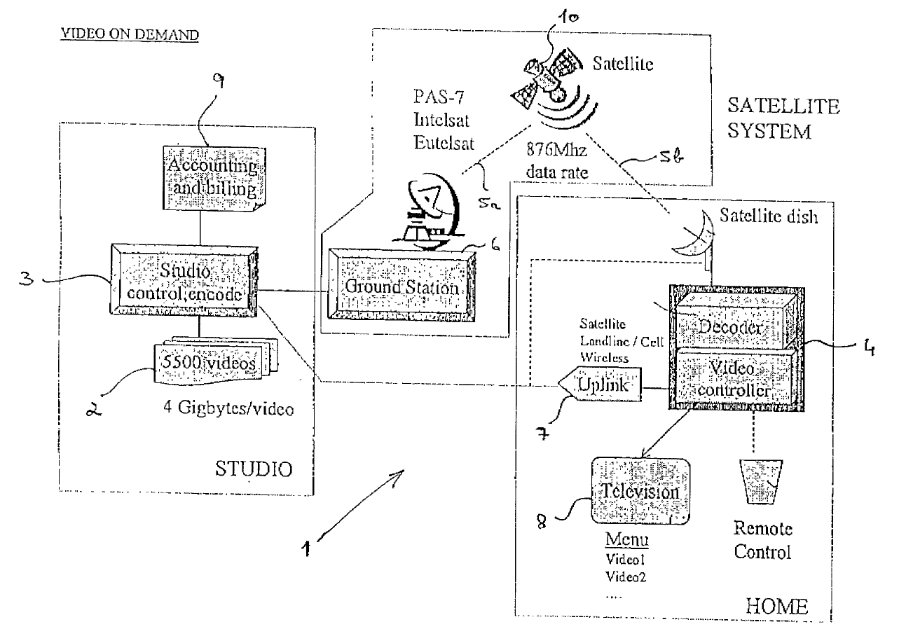

Referring to FIG. 1, a system for providing video on demand is indicated generally by reference numeral (1).

The system (1) includes a repository (2) of video programmes, each video program requiring about 4 Gigabytes of storage, an administration facility (3) associated with the repository of video programmes, one or more television broadcast receivers (4) located remotely from the repository, each television broadcast receiver having an associated storage means in the form of a large capacity hard disk drive (not shown), a satellite communication channel (5a, 5b) between the repository and each television broadcast receiver, transmitter means (6) in the form of a satellite ground station capable of broadcasting any selected one of the video programmes in the repository along the satellite communication channel, and an activation facility (7) that is a return communication channel between the television broadcast receiver and the administration facility.

A video display unit (8) is associated with each one of the television broadcast receivers (4). The system (1) also includes a billing facility (9), the operation of which will be described in greater detail in the description that follows.

The administration facility (3), which is linked to the repository (2), has a register of authorised users (not shown) of the VOD system (1), enabling any authorised user to view any video program in the repository (2) on demand. A person desirous of subscribing to the VOD system (1) is required to first register for the service, whereupon the user's particulars are added to the register of authorised users (not shown).

The satellite communication channel (1) is capable of carrying a television broadcast signal. Transmission of the television broadcast signal occurs along an uplink between the ground station (6) and a transponder (not shown) on a geostationary satellite (10), and a downlink between the satellite (10) and the television broadcast receivers (4). Any video program in the repository (2), which is broadcast along the satellite communication channel (5a, 5b), is stored on the hard disk drive of any television broadcast receiver (4) that receives that particular broadcast. In this embodiment, the return communication channel (7) is a dial-up telecommunication landline to the administration facility (3).

As outlined above example, use of the entire bandwidth of a 12-transponder satellite to provide true VOD, only 384 video-on-demand subscribers can be satisfied at any given time In order to be commercially viable, a VOD system (1) will, of necessity be able to service a far larger number of subscribers. The invention overcomes this limitation by implementing quasi-VOD service in combination with a true VOD service with minimal deterioration in service level for a subscriber.

In use, after registration, a registered user of the VOD system (1) is able to select any one of five levels of service provided by the system.

In a first level of service, a carefully selected bouquet of, say, 10 video programs in the form of popular films is broadcast from time to time, say fortnightly, from the repository (2) along the satellite communication channel (5a, 5b) to the television broadcast receiver (4) of each one of the authorised users of the VOD system. Typically, the selection consists of films that are considered to be “blockbusters” and thus desirable viewing material by a majority of subscribers to the VOD service. The selection of “blockbuster” films is broadcast in this manner during off-peak hours where satellite bandwidth is not fully utilised. Upon reception at the television broadcast receivers (4), the films are stored in the respective hard disk drives (not shown) where they are available for viewing by the authorised users. Since blockbuster films are those expected to have maximum demand, this mode of operation is expected to satisfy the true VOD requirements of approximately two thirds of authonsed users of the system (1).

The size of the hard disk drive (not shown) that is required at each television broadcast receiver (4) is approximately

m*1.2 Gigabytes, where “m” is the number of films in the bouquet.

Each “blockbuster” film will have a residence time on the hard disk drive (not shown) of two weeks, whereafter it will be replaced by a subsequent blockbuster film.

A second level of service provides for an authorised user, upon registration, or at a later stage, to select films that he particularly wishes to see, from a catalogue. The catalogue can be categorised to subdivide the available films in the repository according to themes or genres. As with the “blockbuster” films, the films selected by the subscriber are broadcast along the television broadcast channel (5a, 5b) during off-peak hours, and stored in the hard disk drive (not shown) associated with the subscriber's television broadcast receiver (4). In this level of service, any particular stored film has an indefinite residence time on the hard disk drive (not shown) until such time as the subscriber views that film, whereupon the subscriber is prompted to select a replacement film from the catalogue for downloading from the repository (2)A

A third level of service provides for an authorised user to provide information regarding his film viewing preferences. Upon registration, the user is required to evaluate, say, a sample of 12 video films. A profile of the subscriber's predicted film viewing pattern is derived as a function of the evaluation information provided by the subscriber. A number, say 10, of films matching the predicted viewing pattern are then broadcast along the television broadcast channel (5a, 5b) during off-peak hours, and stored in the hard disk drive (not shown) associated with the subscriber's television broadcast receiver (4). As with the second level of service, any particular stored film has an indefinite residence time on the hard disk drive (not shown) until such time as the subscriber views that film. After a stored film is viewed, the user is required to complete an evaluation of the particular film, and the evaluation is used to refine the subscribers profile. The viewed film is purged from the hard disk drive (not shown) and a replacement film matching the subscribers predicted viewing pattern is broadcast to the user's television broadcast receiver (4) from the repository (2) for storage on the hard disk drive (not shown).

It is envisaged that there will still be a requirement to implement true VOD, as a fourth level of service, where an authorised user wishes to view a film which is not stored in the hard disk drive (not shown) as a consequence of any of the first three levels of service. According to this service level, a requested film is streamed to the subscribers television broadcast receiver (4) utilising the maximum available satellite transponder bandwidth. As outlined the above calculation, 21 videos can be streamed per hour from one transponder having a bandwidth of 39 megabits/sec. This implies that 504 videos can be streamed per transponder in 24 hours, which, it is anticipated will be sufficient to fulfill the majority of subscriber requests for this level of service. If a full satellite carrying 12 transponders were used, 6048 videos could be streamed every 24 hours, which should not necessitate addition satellite capacity.

In a fifth, and final, level of service, an authorised user is pre-notified by means of a satellite broadcast transmission, of promotions offered by an operator of the VOD) system (1). The subscriber is then able to accept the offer and the promotional film, or films, are enabled for viewing thereof by the subscriber.

In order to view a particular video program, whether stored in a subscribers hard disk drive (not shown), or streamed on demand, the subscriber requests a key from the authorisation facility (3) along the return communication channel (7), which is generated by the administration facility and broadcast to the particular subscriber's hard disk drive along the television broadcast channel (5a, 5b). The billing facility (9) bills the subscriber upon occurrence of this event. The administration facility (3) and the billing facility (9) together report periodically to a subscriber which video programs have been viewed, as well as charges levied for viewing of each video program.

It will be appreciated by those skilled in the art that the invention allows the requirements of a large proportion of the authorised user base to be satisfied by means of the “blockbuster”, “own choice” and “personal viewing profile” levels of service described above. Due to the fact that the broadcasting of video programs for these three levels of service can occur in background mode, such as when a subscriber is viewing a stored film, satellite bandwidth can therefore be employed to satisfy viewing requirements of subscribers who wish to view video programs which are not already stored in the hard disk drives (not shown) of their television broadcast receivers (4).

Numerous modifications are possible to this embodiment without departing from the scope of the invention. In particular, the method may include a step of push-pull marketing in which subscribers are reminded that stored video films will be erased from the hard disk drives (not shown) after a predetermined time limit. Further, the administration facility (3) can accumulate all requests for new films over, say, a twelve-hour period and, wherever possible, send the requested videos simultaneously to as many customers as possible, thereby minimising transponder bandwidth utilisation. This implies that a subscriber may only have access to a VOD service 12 hours, or even longer, after initial registration as an authorised user, but it is not envisaged that this will be a problem. Still further an authorised user's consumption pattern of the “blockbuster” films could also be used to refine that user's personal viewing pattern. Yet further, viewing pattern data from video outlet stores could be utilised to determine any bouquet of “blockbuster” films. Still further, the return communication channel may consist of a satellite return path instead of the telecommunication landline. The landline may be leased or dial-up, and may be fixed-line or a mobile telecommunication circuit such as GSM.

Yet further, the administration facility (3) manages financial aspects of the VOD system (1), including credit control against payments by authorised users for their respective usage of the system. Payments by users can be implemented by software adapted to carry out electronic transfer of money from users' banks or other accounts according to a regimen of payment schedules that are captured in the register of authorised users (not shown).

The invention therefore provides a VOD system which is transparent to a user thereof and which uses a combination of local buffering and video streaming to provide a quasi-VOD system, in combination with true VOD, that simulates the operation of a true satellite-based video-on-demand system.

1. A system for providing a video-on-demand service, comprising:
a repository of video programmes;
an administration facility associated with the repository of video programmes, the administration facility having a register of authorised users of the repository;
at least one television broadcast receiver remote from the repository, the at least one television broadcast receiver having an associated storage means;
a satellite communication channel between the repository and the at least one television broadcast receiver, the satellite communication channel being capable of carrying a television broadcast signal;
transmitter means capable of broadcasting any selected one of the video programmes in the repository along the satellite communication channel, the broadcast selected one of the video programmes being stored, at least partially, upon reception thereof, in the associated storage means; and
an activation facility responsive to a request by a registered user to enable the stored selected one of the video programmes for viewing on the television broadcast receiver.

2. A system according to claim 1 which includes a billing facility operable to bill the registered user of the system as a function of a number of stored video programmes viewed by the registered user.

3. A system as claimed in claim 1 in which the activation facility is a return communication channel operable by the registered user to access the administration facility.

4. A system as claimed in claim 3 in which the return communication channel is a terrestrial or a satellite telecommunication circuit.

5. A system as claimed in claim 4 in which the terrestrial or satellite telecommunication circuit is a leased or a dial-up telecommunication circuit.

6. A system as claimed in claim 1 in which a plurality of selected video programmes in the repository is broadcast along the satellite communication channel and stored in the storage means associated with the at least one television broadcast receiver.

7. A system as claimed in claim 6 in which the activation facility is operable by the registered user to enable any one of the plurality of selected stored video programmes for viewing on the television broadcast receiver.

8. A system as claimed in claim 6 in which the plurality of video programmes transmitted from the repository and stored in the storage means is selected at the discretion of the registered user.

9. A system as claimed in claim 6 in which the plurality of video programmes transmitted from the repository and stored in the storage means is selected according to box office ratings.

10. A system as claimed in claim 6 in which the plurality of video programmes transmitted from the repository and stored in the storage means is selected as a function of a historical viewing pattern of the registered user.

11. A system as claimed in claim 10 in which the historical viewing pattern of the registered user is determined as a function of an evaluation of any video programme after viewing thereof by the registered user.

12. A system as claimed in claim 6 in which the plurality of video programmes transmitted from the repository and stored in the storage means has a finite residence time in the storage means.

13. A system as claimed in claim 12 in which a stored video programme is erased from the storage means after effluxion of the finite residence time.

14. A system as claimed in claim 6 in which the plurality of video programmes is stored in the storage means until viewed by the registered user.

15. A system as claimed in claim 1 in which the administration facility prompts the registered user to select a replacement video programme for transmission and storage after erasure of any video programme from the storage means

16. A method for providing a video-on-demand service, comprising the steps of:
providing a repository of video programmes;
providing an administration facility associated with the repository of video programmes, the administration facility having a register of authorised users of the repository;
providing at least one television broadcast receiver remote from the repository, the at least one television broadcast receiver having an associated storage means;
broadcasting any selected one of the video programmes in the repository along a satellite communication channel to the at least one television broadcast receiver;
storing, at least partially, the broadcast selected one of the video programmes, upon reception thereof, in the associated storage means; and
enabling the stored selected one of the video programmes for viewing on the television broadcast receiver in response to a request by a registered user.

17. A method as claimed in claim 16 that includes the step of billing the registered user as a function of a number of stored video programmes viewed by the registered user.

18. A method as claimed in claim 16 in which the stored selected one of the video programs is enabled for viewing by submitting a request to the administration facility.

19. A method as claimed in claim 18 in which the request to the administration facility is submitted along a dial up telecommunication circuit.

20. A method as claimed in claim 16 which include the further steps of broadcasting a plurality of selected video programmes in the repository along the satellite communication channel and storing the plurality of selected video programmes in the storage means associated with the at least one television broadcast receiver.

21. A method as claimed in claim 20 which provides for enabling any one of the stored selected video programmes for viewing on the television broadcast receiver in response to a request by the registered user.

22. A method as claimed in claim 20 in which the plurality of video programmes transmitted from the repository and stored in the storage means is selected at the discretion of the registered user.

23. A method as claimed in claim 20 in which the plurality of video programmes transmitted from the repository and stored in the storage means is selected according to box office ratings.

24. A method as claimed in claim 20 in which the plurality of video programmes transmitted from the repository and stored in the storage means is selected as a function of a historical viewing pattern of the registered user.

25. A method as claimed in claim 24 in which or determining the historical viewing pattern of the registered user is determined as a function of an evaluation of any video programme after viewing thereof by the registered user.

26. A method as claimed in claim 20 in which the plurality of video programmes transmitted from the repository and stored in the storage means have a finite residence time in the storage means.

27. A method as claimed in claim 26 that includes the additional step of erasing a stored video programme from the storage means after effluxion of the finite residence time.

28. A method as claimed in claim 20 in which the plurality of video programmes transmitted from the repository are stored in the storage means until viewed by the registered user.

29. A method as claimed in claim 20 that includes the step of prompting the registered user to select a replacement video programme for transmission and storage after erasure of any video programme from the storage means.
